(19) United States
(12) Patent Application Publication
(10) Pub. No.: US 2019/0162886 A1
(43) Pub. Date: May 30, 2019

(54) INVISIBLE LIGHT BLOCKING STRUCTURE

(71) Applicant: Nanostar Technology Co., LTD., Kaohsiung City (TW)

(72) Inventors: Horng-Hwa LU, Tainan City (TW); Wen-Fu CHEN, Kaohsiung City (TW); Wen-Liang CHEN, Kaohsiung City (TW); Yin-Hsien LAI, Kaohsiung City (TW)

(21) Appl. No.: 16/141,965

(22) Filed: Sep. 25, 2018

(30) Foreign Application Priority Data
Nov. 24, 2017 (TW) 106217553

(51) Int. Cl. G02B 5/20; G02B 1/18

(52) U.S. Cl. CPC G02B 5/208; G02B 1/18

(57) ABSTRACT

An invisible light blocking structure includes a first transparent substrate, a metal layer, a transparent protecting layer and an invisible light blocking unit. The first transparent substrate has a first bottom side and a first upper side. The metal layer is disposed on the first bottom side and has a first metal side facing away from the first transparent substrate. The first upper side faces away from the metal layer. The transparent protecting layer is disposed on the first metal side. The transparent protecting layer has a first protecting side facing away from the first transparent substrate. The invisible light blocking unit is disposed on at least one of a first protecting side and the first upper side. The invisible light blocking unit has cesium tungstate.

### RELATED APPLICATIONS

This application claims priority to Taiwan Application Serial Number 106217553, filed Nov. 24, 2017, which is herein incorporated by reference.

### BACKGROUND

### Technical Field

The present disclosure relates to a light blocking structure. More particularly, the present disclosure relates to an invisible light blocking structure.

### Description of Related Art

Recently, in addition to develop new energy sources, scientists start to find ways to reduce energy owing to the lack of energy sources. Consequently, low energy cost equipment or components of architecture, such as energy efficient windows, are developed for energy reduction.

Because of the development of industry and commerce, business buildings stand in a great number, and many business buildings adapt glass windows for getting more daylight. However, because of the high transmittance of the glass, thermal radiation passes through the glass to enter the room, and the usage of air conditioners is increased; accordingly, carbon dioxide emissions as well as usage of energy are increased, which runs counter to the energy saving. Consequently, scientists developed energy efficient widows for blocking the heat radiation. The glass is coated with specific layer. Not only can the infrared light be blocked, but also the transparence of the glass can be remained. However, the capability for blocking the infrared light of such glass is still limited.

Bases on the abovementioned problems, how to improve the structure of the energy efficient windows to enhance the capability of blocking invisible light becomes a pursuit target for practitioners.

### SUMMARY

The present disclosure provides an invisible light blocking structure including a first transparent substrate, a metal layer, a transparent protecting layer and an invisible light blocking unit. The first transparent substrate has a first bottom side and a first upper side. The metal layer is disposed on the first bottom side and has a first metal side facing away from the first transparent substrate. The first upper side faces away from the metal layer. The transparent protecting layer is disposed on the first metal side. The transparent protecting layer has a first protecting side facing away from the first transparent substrate. The invisible light blocking unit is disposed on at least one of the first protecting side and the first upper side. The invisible light blocking unit has cesium tungstate.

### BRIEF DESCRIPTION OF THE DRAWINGS

The present disclosure can be more fully understood by reading the following detailed description of the embodiment, with reference made to the accompanying drawings as follows:

FIG. 1 shows a side view of an invisible light blocking structure according to a 1st example of the present disclosure.

FIG. 2 shows a side view of an invisible light blocking structure according to a 2nd example of the present disclosure.

FIG. 3 shows a side view of an invisible light blocking structure according to a 3rd example of the present disclosure.

FIG. 4 shows a side view of an invisible light blocking structure according to a 4th example of the present disclosure.

FIG. 5 shows a side view of an invisible light blocking structure according to a 5th example of the present disclosure.

FIG. 6 shows a side view of an invisible light blocking structure according to a 6th example of the present disclosure.

FIG. 7 shows a side view of an invisible light blocking structure according to a 7th example of the present disclosure.

FIG. 8 shows a side view of an invisible light blocking structure according to an 8th example of the present disclosure.

FIG. 9 shows a side view of an invisible light blocking structure according to a 9th example of the present disclosure.

FIG. 10 shows a side view of an invisible light blocking structure according to a 10th example of the present disclosure.

FIG. 11 shows a side view of an invisible light blocking structure according to an 11th example of the present disclosure.

FIG. 12 shows a side view of an invisible light blocking structure according to a 12th example of the present disclosure.

FIG. 13 shows a side view of an invisible light blocking structure according to a 13th example of the present disclosure.

FIG. 14 shows a side view of an invisible light blocking structure according to a 14th example of the present disclosure.

FIG. 15 shows a side view of an invisible light blocking structure according to a 15th example of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details being unnecessary. In addition, for simplifying the drawings, some conventional structures and elements will be simply illustrated, and repeated elements may be represented by the same labels.

The invisible light blocking structure in the present disclosure includes a first transparent substrate, a metal layer, a transparent protecting layer and an invisible light blocking unit. The first transparent substrate has a first bottom side and a first upper side. The metal layer is disposed on the first bottom side and has a first metal side facing away from the first transparent substrate. The first upper side faces away from the metal layer. The transparent protecting layer is disposed on the first metal side. The transparent protecting layer has a first protecting side facing away from the first transparent substrate. The invisible light blocking unit is disposed on at least one of the first protecting side and the first upper side. The invisible light blocking unit has cesium tungstate. In one embodiment, the invisible light blocking unit can be composed of an infrared light blocking layer. In another embodiment, the invisible light blocking unit can be composed of an infrared light blocking layer and an ultraviolet light blocking layer. In yet another embodiment, the invisible light blocking unit can be composed of an ultraviolet and infrared light blocking layer to simultaneously block the ultraviolet light and the infrared light. Preferably, a component of the metal layer can be Ag, Al, Cr, Ni, In, Ti or Sn.

Therefore, because the invisible light blocking structure includes isolated metal layer and the invisible light blocking unit, the invisible light blocking structure can has better transmission while the invisible light blocking capacity is remained well.

In one embodiment, the invisible light blocking structure includes the first transparent substrate, the metal layer, the transparent protecting layer and the invisible light blocking unit. The metal layer is disposed on the first bottom side. The transparent protecting layer is disposed on the first metal side. The invisible light blocking unit is disposed on the first protecting side and has the cesium tungstate.

The first transparent substrate can be made of glass material. The infrared light blocking layer of the invisible light blocking unit can include a cesium tungstate film containing the cesium tungstate, which can be manufactured by chemical vapor deposition (CVD) or physical vapor deposition (PVD). The thickness of the cesium tungstate film is in a range from 10 nm to 1000 nm. In another example, the infrared light blocking layer may include a cesium tungstate-containing silicone sealant including a polymer-containing silicone sealant colloid and a plurality of nanoparticles. The polymer-containing silicone sealant colloid includes silane resin-containing group, acrylic resin-containing group, polyurethane-containing group and epoxy resin-containing group. The nanoparticles are dispersed uniformly in the polymer-containing silicone sealant colloid and contain the cesium tungstate. The cesium tungstate film may be made by coating, printing or screen printing and has a thickness in a range from 1 μm to 50 μm. Preferably, the weight percentage of the silane resin-containing group is in a range from 0.5% to 90%. The weight percentage of the acrylic resin-containing group is in a range from 3% to 90%. The weight percentage of the polyurethane-containing group is in a range from 3% to 90%. The weight percentage of the epoxy resin-containing group is in a range from 3% to 90%. The weight percentage of the nanoparticles is in a range from 0.5% to 90%.

In another embodiment, the invisible light blocking structure includes the first transparent substrate, the metal layer, the transparent protecting layer and the invisible light blocking unit. The metal layer is disposed on the first bottom side. The transparent protecting layer is disposed on the first metal side. The invisible light blocking unit includes an infrared light blocking layer and an ultraviolet light blocking layer. The infrared light blocking layer is disposed on the first protecting side and contains the cesium tungstate. The ultraviolet light blocking layer is disposed between the transparent protecting layer and the infrared light layer, on the first upper side, or on a first side of the infrared light blocking layer, and the first side of the infrared light blocking unit faces away from the transparent protecting layer.

The ultraviolet light blocking layer can include cerium oxide or zinc oxide. The ultraviolet light blocking layer can include a cerium oxide film containing the cerium oxide, which can be manufactured by chemical vapor deposition (CVD) or physical vapor deposition (PVD). The thickness of the cerium oxide film is in a range from 10 nm to 1000 nm. In another example, the ultraviolet light blocking layer may include a cerium oxide-containing silicone sealant including a polymer-containing silicone sealant colloid and a plurality of nanoparticles. The polymer-containing silicone sealant colloid includes silane resin-containing group, acrylic resin-containing group, polyurethane-containing group and epoxy resin-containing group. The nanoparticles are dispersed uniformly in the polymer-containing silicone sealant colloid and contain the cerium oxide. The cerium oxide film may be made by coating, printing or screen printing and has a thickness in a range from 1 μm to 50 μm. The cerium oxide can be replaced by the zinc oxide. Preferably, the weight percentage of the silane resin-containing group is in a range from 0.5% to 90%. The weight percentage of the acrylic resin-containing group is in a range from 3% to 90%. The weight percentage of the polyurethane-containing group is in a range from 3% to 90%. The weight percentage of the epoxy resin-containing group is in a range from 3% to 90%. The weight percentage of the nanoparticles is in a range from 0.5% to 90%.

In yet another embodiment, the invisible light blocking structure includes the first transparent substrate, the metal layer, the transparent protecting layer, the invisible light blocking unit and a second transparent substrate. The metal layer is disposed on the first bottom side. The transparent protecting layer is disposed on the first metal side. The invisible light blocking unit includes an infrared light blocking layer and an ultraviolet light blocking layer. The infrared light blocking layer is disposed on the first protecting side and contains the cesium tungstate. The ultraviolet light blocking layer is disposed between the transparent protecting layer and the infrared light layer, between the metal layer and the first transparent substrate, or on the first side of the infrared light blocking layer. The second transparent substrate is disposed between the first transparent substrate and the metal layer, between the transparent protecting layer and the infrared light blocking layer, or on the first side of the infrared light blocking layer.

For example, the ultraviolet light blocking layer is disposed between the metal layer and the first transparent substrate, and the second transparent substrate is disposed between the ultraviolet light blocking layer and the metal layer. The ultraviolet light blocking layer is disposed between the transparent protecting layer and the infrared light blocking layer, and the second transparent substrate is disposed between the ultraviolet light blocking layer and the infrared light blocking layer. The ultraviolet light blocking layer is disposed on the first side of the infrared light blocking layer, and the second transparent substrate is disposed on a first side of the ultraviolet light blocking layer. The first side of the ultraviolet light blocking layer faces away from the transparent protecting layer.

The second transparent substrate can be made of glass material. The ultraviolet light blocking layer can include a polyvinyl butyral resin (PVB resin) and an organic UV absorber, and the organic UV absorber is dispersed in the polyvinyl butyral resin. In other word, the organic UV absorber is mixed with the polyvinyl butyral resin and a plasticizer to form a mixture, and then the mixture is extruded to form a PVB film with ultraviolet light blocking capacity. The organic UV absorber can be the Eversorb 732FD produced by Taiwan Everlight Chemical Industrial Corporation. Preferably, the weight percentage of the organic UV absorber can be in a range from 0.1% to 10%. The weight percentage of the polyvinyl butyral resin can be in a range from 64% to 85%. The weight percentage of the plasticizer can be in a range from 14% to 35%.

Therefore, when the ultraviolet light blocking layer is disposed between the first transparent substrate and the second transparent substrate, the PVB film with ultraviolet light blocking capacity is assisted for adhesive bonding between the first transparent substrate and the second transparent substrate. Moreover, when the ultraviolet light blocking layer is disposed on the first side of the infrared light blocking layer, the ultraviolet light blocking layer can provide protection for the other layers such that the other layers will not be affected by the circumstance.

In still yet another embodiment, the invisible light blocking structure includes the first transparent substrate, the metal layer, the transparent protecting layer, the invisible light blocking unit and the second transparent substrate. The metal layer is disposed on the first bottom side. The transparent protecting layer is disposed on the first metal side. The invisible light blocking unit is disposed on the first protecting side and includes an ultraviolet and infrared light blocking layer. The ultraviolet and infrared light blocking layer has a first blocking side facing away from the transparent protecting layer, and includes a polyvinyl butyral resin, an organic UV absorber and a plurality of nanoparticles. The organic UV absorber is dispersed in the polyvinyl butyral resin. The nanoparticles are dispersed in the polyvinyl butyral resin and contain the cesium tungstate. The second transparent substrate is disposed on the first blocking side.

The ultraviolet and infrared light blocking layer includes the polyvinyl butyral resin, the organic UV absorber and the plurality of nanoparticles. The organic UV absorber is dispersed in the polyvinyl butyral resin. The nanoparticles are dispersed in the polyvinyl butyral resin and contain the cesium tungstate. In other word, the organic UV absorber is mixed with the polyvinyl butyral resin, the nanoparticles and a plasticizer to form a mixture, and then the mixture is extruded to form a PVB film with ultraviolet and infrared light blocking capacity. Preferably, the weight percentage of the organic UV absorber can be in a range from 0.1% to 10%. The weight percentage of the polyvinyl butyral resin can be in a range from 5% to 90%. The weight percentage of the nanoparticles can be in a range from 1% to 90%.

The abovementioned invisible light blocking structure can further include a self-cleaning layer. The self-cleaning layer is disposed on the first upper side and has fluorine. In one embodiment, the self-cleaning layer can include a fluorine film containing the fluorine, which can be manufactured by chemical vapor deposition or physical vapor deposition. The thickness of the fluorine film is in a range from 10 nm to 1000 nm. In another embodiment, the self-cleaning layer may include a fluorine-containing silicone sealant including a polymer-containing silicone sealant colloid and a plurality of fluororesin-containing nanoparticles. The polymer-containing silicone sealant colloid includes silane resin-containing group, acrylic resin-containing group, polyurethane-containing group and epoxy resin-containing group. The fluororesin-containing nanoparticles are dispersed uniformly in the polymer-containing silicone sealant colloid and contain the fluorine. The fluorine film may be made by coating, printing or screen printing, and has a thickness in a range from 1 μm to 50 μm. Preferably, the weight percentage of the polymer-containing silicone sealant colloid is in a range from 10% to 99.9%. The weight percentage of fluororesin-containing nanoparticles is in a range from 0.1% to 90%.

Based on the abovementioned description, examples are described in detail with the drawings.

### Examples

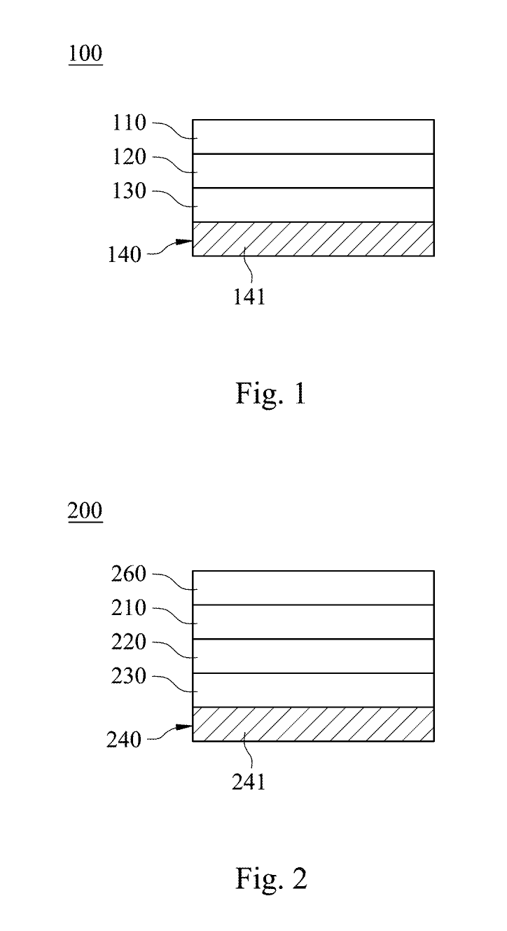

Please refer to FIG. 1. FIG. 1 shows a side view of an invisible light blocking structure 100 according to a 1st example of the present disclosure. In the 1st example, the invisible light blocking unit 140 includes an infrared light blocking layer 141. The invisible light blocking structure 100 includes, from an upper side to a bottom side, a first transparent substrate 110, a metal layer 120, a transparent protecting layer 130 and the infrared light blocking layer 141. The component of the metal layer 120 is Ag, but the component thereof can be Al, Cr, Ni, In, Ti or Sn in another example. The transparent protecting layer 130 is a silicon oxide film manufactured by physical vapor deposition and has a thickness of 50 nm. The transparent protecting layer 130 can be a titanium oxide film or an aluminum oxide film in another example. The infrared light blocking layer 141 is a continuous cesium tungstate film manufactured by physical vapor deposition and has a thickness of 200 nm. The infrared light blocking layer 141 can be a discontinuous cesium tungstate film formed from a cesium tungstate-containing silicone sealant in another example.

Please refer to FIG. 2. FIG. 2 shows a side view of an invisible light blocking structure 200 according to a 2nd example of the present disclosure. In the 2nd example, the invisible light blocking unit 240 includes an infrared light blocking layer 241. The invisible light blocking structure 200 includes, from an upper side to a bottom side, a self-cleaning layer 260, a first transparent substrate 210, a metal layer 220, a transparent protecting layer 230 and the infrared light blocking layer 241. The self-cleaning layer 260 is a continuous fluorine film manufactured by physical vapor deposition and has a thickness of 500 nm. The self-cleaning layer 260 can be a discontinuous fluorine film formed from a fluorine-containing silicone sealant in another example. The component of the metal layer 220 is Ag, but the component thereof can be Al, Cr, Ni, In, Ti or Sn in another example. The transparent protecting layer 230 is a silicon oxide film manufactured by physical vapor deposition and has a thickness of 50 nm. The transparent protecting layer 230 can be a titanium oxide film or an aluminum oxide film in another example. The infrared light blocking layer 241 is a continuous cesium tungstate film manufactured by physical vapor deposition and has a thickness of 200 nm. The infrared light blocking layer 241 can be a discontinuous cesium tungstate film formed from a cesium tungstate-containing silicone sealant in another example.

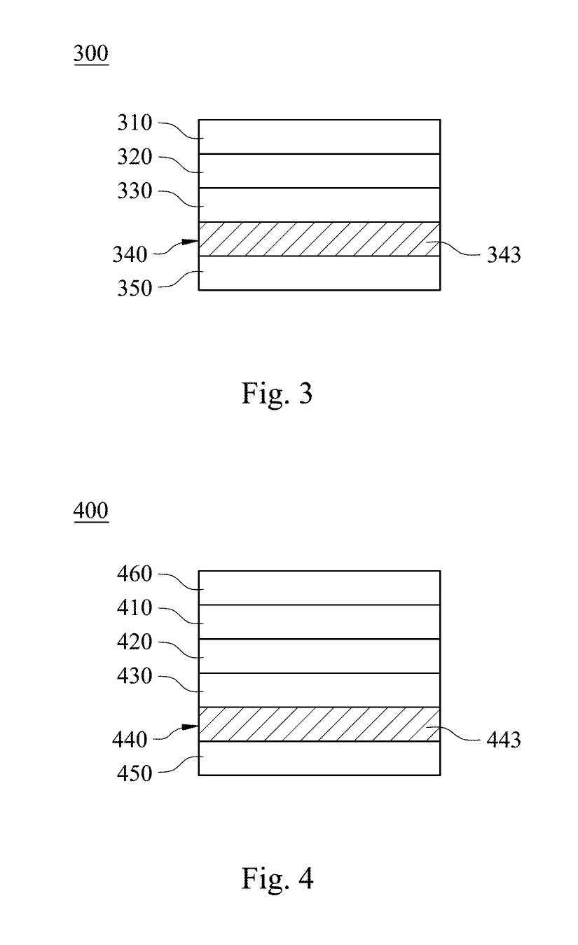

Please refer to FIG. 3. FIG. 3 shows a side view of an invisible light blocking structure 300 according to a 3rd example of the present disclosure. In the 3rd example, the invisible light blocking unit 340 includes an ultraviolet and infrared light blocking layer 343. The invisible light blocking structure 300 includes, from an upper side to a bottom side, a first transparent substrate 310, a metal layer 320, a transparent protecting layer 330, the ultraviolet and infrared light blocking layer 343 and the second transparent substrate 350. The component of the metal layer 320 is Ag, but the component thereof can be Al, Cr, Ni, In, Ti or Sn in another example. The transparent protecting layer 330 is a silicon oxide film manufactured by physical vapor deposition and has a thickness of 50 nm. The transparent protecting layer 330 can be a titanium oxide film or an aluminum oxide film in another example. The ultraviolet and infrared light blocking layer 343 is formed by a PVB film with ultraviolet and infrared light blocking capability.

Please refer to FIG. 4. FIG. 4 shows a side view of an invisible light blocking structure 400 according to a 4th example of the present disclosure. In the 4th example, the invisible light blocking unit 440 includes an ultraviolet and infrared light blocking layer 443. The invisible light blocking structure 400 includes, from an upper side to a bottom side, a self-cleaning layer 460, a first transparent substrate 410, a metal layer 420, a transparent protecting layer 430, the ultraviolet and infrared light blocking layer 443 and a second transparent substrate 450. The self-cleaning layer 460 is a continuous fluorine film manufactured by physical vapor deposition and has a thickness of 500 nm. The self-cleaning layer 460 can be a discontinuous fluorine film formed from a fluorine-containing silicone sealant in another example. The component of the metal layer 420 is Ag, but the component thereof can be Al, Cr, Ni, In, Ti or Sn in another example. The transparent protecting layer 430 is a silicon oxide film manufactured by physical vapor deposition and has a thickness of 50 nm. The transparent protecting layer 430 can be a titanium oxide film or an aluminum oxide film in another example. The ultraviolet and infrared light blocking layer 443 is formed by a PVB film with ultraviolet and infrared light blocking capability.

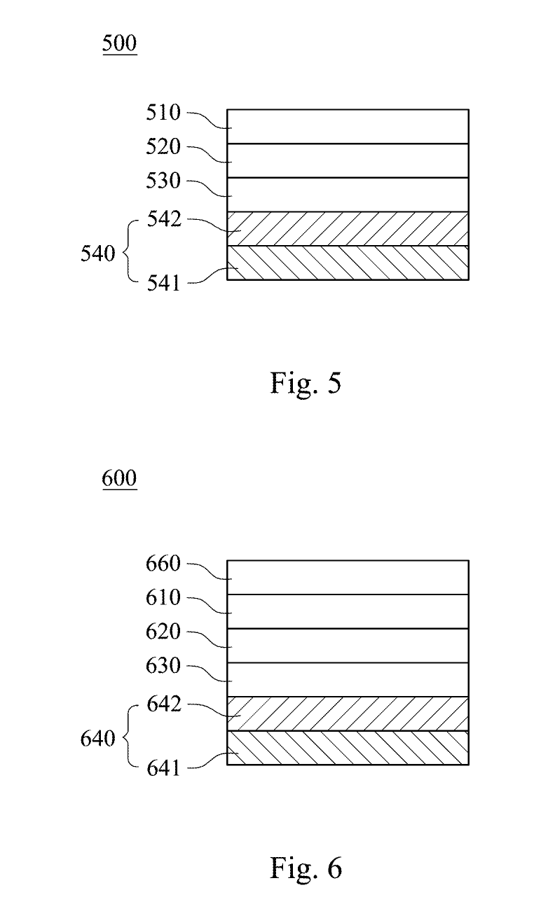

Please refer to FIG. 5. FIG. 5 shows a side view of an invisible light blocking structure 500 according to a 5th example of the present disclosure. In the 5th example, the invisible light blocking unit 540 includes an infrared light blocking layer 541 and an ultraviolet light blocking layer 542. The invisible light blocking structure 500 includes, from an upper side to a bottom side, a first transparent substrate 510, a metal layer 520, a transparent protecting layer 530, the ultraviolet light blocking layer 542 and the infrared light blocking layer 541. The component of the metal layer 520 is Ag, but the component thereof can be Al, Cr, Ni, In, Ti or Sn in another example. The transparent protecting layer 530 is a silicon oxide film manufactured by physical vapor deposition and has a thickness of 50 nm. The transparent protecting layer 530 can be a titanium oxide film or an aluminum oxide film in another example. The ultraviolet light blocking layer 542 is a continuous zinc oxide film manufactured by physical vapor deposition and has a thickness of 500 nm. The ultraviolet light blocking layer 542 can be a discontinuous cerium oxide film formed from a cerium oxide-containing silicone sealant in another example. The infrared light blocking layer 541 is a continuous cesium tungstate film manufactured by physical vapor deposition and has a thickness of 200 nm. The infrared light blocking layer 541 can be a discontinuous cesium tungstate film formed from a cesium tungstate-containing silicone sealant in another example.

Please refer to FIG. 6. FIG. 6 shows a side view of an invisible light blocking structure 600 according to a 6th example of the present disclosure. In the 6th example, the invisible light blocking unit 640 includes an infrared light blocking layer 641 and an ultraviolet light blocking layer 642. The invisible light blocking structure 600 includes, from an upper side to a bottom side, a self-cleaning layer 660, a first transparent substrate 610, a metal layer 620, a transparent protecting layer 630, the ultraviolet light blocking layer 642 and the infrared light blocking layer 641. The self-cleaning layer 660 is a continuous fluorine film manufactured by physical vapor deposition and has a thickness of 500 nm. The self-cleaning layer 660 can be a discontinuous fluorine film formed from a fluorine-containing silicone sealant in another example. The component of the metal layer 620 is Ag, but the component thereof can be Al, Cr, Ni, In, Ti or Sn in another example. The transparent protecting layer 630 is a silicon oxide film manufactured by physical vapor deposition and has a thickness of 50 nm. The transparent protecting layer 630 can be a titanium oxide film or an aluminum oxide film in another example. The ultraviolet light blocking layer 642 is a continuous zinc oxide film manufactured by physical vapor deposition and has a thickness of 500 nm. The ultraviolet light blocking layer 642 can be a discontinuous cerium oxide film formed from a cerium oxide-containing silicone sealant in another example. The infrared light blocking layer 641 is a continuous cesium tungstate film manufactured by physical vapor deposition and has a thickness of 200 nm. The infrared light blocking layer 641 can be a discontinuous cesium tungstate film formed from a cesium tungstate-containing silicone sealant in another example.

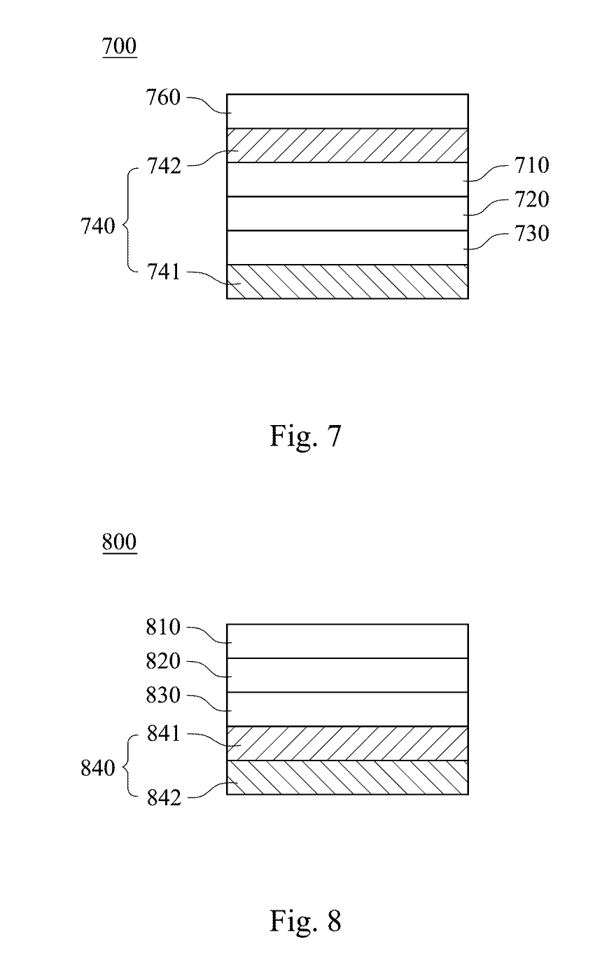

Please refer to FIG. 7. FIG. 7 shows a side view of an invisible light blocking structure 700 according to a 7th example of the present disclosure. In the 7th example, the invisible light blocking unit 740 includes an infrared light blocking layer 741 and an ultraviolet light blocking layer 742. The invisible light blocking structure 700 includes, from an upper side to a bottom side, a self-cleaning layer 760, the ultraviolet light blocking layer 742, a first transparent substrate 710, a metal layer 720, a transparent protecting layer 730 and the infrared light blocking layer 741. The self-cleaning layer 760 is a continuous fluorine film manufactured by physical vapor deposition and has a thickness of 500 nm. But the self-cleaning layer 760 can be a discontinuous fluorine film formed from a fluorine-containing silicone sealant in another example. The ultraviolet light blocking layer 742 is a continuous zinc oxide film manufactured by physical vapor deposition and has a thickness of 500 nm. The ultraviolet light blocking layer 742 can be a discontinuous cerium oxide film formed from a cerium oxide-containing silicone sealant in another example. The component of the metal layer 720 is Ag, but the component thereof can be Al, Cr, Ni, In, Ti or Sn in another example. The transparent protecting layer 730 is a silicon oxide film manufactured by physical vapor deposition and has a thickness of 50 nm. The transparent protecting layer 730 can be a titanium oxide film or an aluminum oxide film in another example. The infrared light blocking layer 741 is a continuous cesium tungstate film manufactured by physical vapor deposition and has a thickness of 200 nm. The infrared light blocking layer 741 can be a discontinuous cesium tungstate film formed from a cesium tungstate-containing silicone sealant in another example.

Please refer to FIG. 8. FIG. 8 shows a side view of an invisible light blocking structure 800 according to an 8th example of the present disclosure. In the 8th example, the invisible light blocking unit 840 includes an infrared light blocking layer 841 and an ultraviolet light blocking layer 842. The invisible light blocking structure 800 includes, from an upper side to a bottom side, a first transparent substrate 810, a metal layer 820, a transparent protecting layer 830, the infrared light blocking layer 841 and the ultraviolet light blocking layer 842. The component of the metal layer 820 is Ag, but the component thereof can be Al, Cr, Ni, In, Ti or Sn in another example. The transparent protecting layer 830 is a silicon oxide film manufactured by physical vapor deposition and has a thickness of 50 nm. The transparent protecting layer 830 can be a titanium oxide film or an aluminum oxide film in another example. The infrared light blocking layer 841 is a continuous cesium tungstate film manufactured by physical vapor deposition and has a thickness of 200 nm. The infrared light blocking layer 841 can be a discontinuous cesium tungstate film formed from a cesium tungstate-containing silicone sealant in another example. The ultraviolet light blocking layer 842 is a continuous zinc oxide film manufactured by physical vapor deposition and has a thickness of 500 nm. The ultraviolet light blocking layer 842 can be a discontinuous cerium oxide film formed from a cerium oxide-containing silicone sealant in another example.

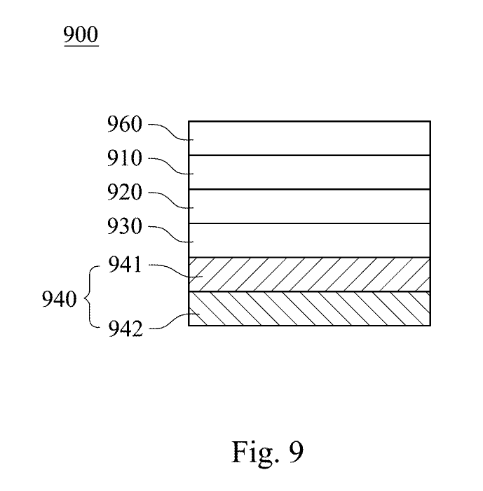

Please refer to FIG. 9. FIG. 9 shows a side view of an invisible light blocking structure 900 according to a 9th example of the present disclosure. In the 9th example, the invisible light blocking unit 940 includes an infrared light blocking layer 941 and an ultraviolet light blocking layer 942. The invisible light blocking structure 900 includes, from an upper side to a bottom side, a self-cleaning layer 960, a first transparent substrate 910, a metal layer 920, a transparent protecting layer 930, the infrared light blocking layer 941 and the ultraviolet light blocking layer 942. The self-cleaning layer 960 is a continuous fluorine film manufactured by physical vapor deposition and has a thickness of 500 nm. The self-cleaning layer 960 can be a discontinuous fluorine film formed from a fluorine-containing silicone sealant in another example. The component of the metal layer 920 is Ag, but the component thereof can be Al, Cr, Ni, In, Ti or Sn in another example. The transparent protecting layer 930 is a silicon oxide film manufactured by physical vapor deposition and has a thickness of 50 nm. The transparent protecting layer 930 can be a titanium oxide film or an aluminum oxide film in another example. The infrared light blocking layer 941 is a continuous cesium tungstate film manufactured by physical vapor deposition and has a thickness of 200 nm. The infrared light blocking layer 941 can be a discontinuous cesium tungstate film formed from a cesium tungstate-containing silicone sealant in another example. The ultraviolet light blocking layer 942 is a continuous zinc oxide film manufactured by physical vapor deposition and has a thickness of 500 nm. The ultraviolet light blocking layer 942 can be a discontinuous cerium oxide film formed from a cerium oxide-containing silicone sealant in another example.

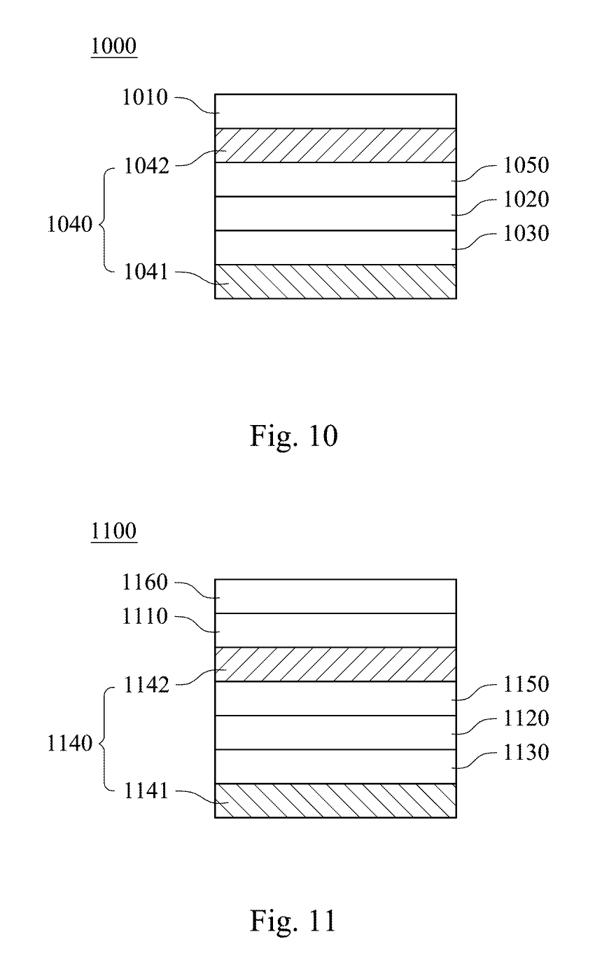

Please refer to FIG. 10. FIG. 10 shows a side view of an invisible light blocking structure 1000 according to a 10th example of the present disclosure. In the 10th example, the invisible light blocking unit 1040 includes an infrared light blocking layer 1041 and an ultraviolet light blocking layer 1042. The invisible light blocking structure 1000 includes, from an upper side to a bottom side, a first transparent substrate 1010, the ultraviolet light blocking layer 1042, a second transparent substrate 1050, a metal layer 1020, a transparent protecting layer 1030 and the infrared light blocking layer 1041. The ultraviolet light blocking layer 1042 is formed by a PVB film with ultraviolet light blocking capacity. The component of the metal layer 1020 is Ag, but the component thereof can be Al, Cr, Ni, In, Ti or Sn in another example. The transparent protecting layer 1030 is a silicon oxide film manufactured by physical vapor deposition and has a thickness of 50 nm. The transparent protecting layer 1030 can be a titanium oxide film or an aluminum oxide film in another example. The infrared light blocking layer 1041 is a continuous cesium tungstate film manufactured by physical vapor deposition and has a thickness of 200 nm. The infrared light blocking layer 1041 can be a discontinuous cesium tungstate film formed from a cesium tungstate-containing silicone sealant in another example.

Please refer to FIG. 11. FIG. 11 shows a side view of an invisible light blocking structure 1100 according to an 11th example of the present disclosure. In the 11th example, the invisible light blocking unit 1140 includes an infrared light blocking layer 1141 and an ultraviolet light blocking layer 1142. The invisible light blocking structure 1100 includes, from an upper side to a bottom side, a self-cleaning layer 1160, a first transparent substrate 1110, the ultraviolet light blocking layer 1142, a second transparent substrate 1150, a metal layer 1120, a transparent protecting layer 1130 and the infrared light blocking layer 1141. The self-cleaning layer 1160 is a continuous fluorine film manufactured by physical vapor deposition and has a thickness of 500 nm. The self-cleaning layer 1160 can be a discontinuous fluorine film formed from a fluorine-containing silicone sealant in another example. The ultraviolet light blocking layer 1142 is formed by a PVB film with ultraviolet light blocking capacity. The component of the metal layer 1120 is Ag, but the component thereof can be Al, Cr, Ni, In, Ti or Sn in another example. The transparent protecting layer 1130 is a silicon oxide film manufactured by physical vapor deposition and has a thickness of 50 nm. The transparent protecting layer 1130 can be a titanium oxide film or an aluminum oxide film in another example. The infrared light blocking layer 1141 is a continuous cesium tungstate film manufactured by physical vapor deposition and has a thickness of 200 nm. The infrared light blocking layer 1141 can be a discontinuous cesium tungstate film formed from a cesium tungstate-containing silicone sealant in another example.

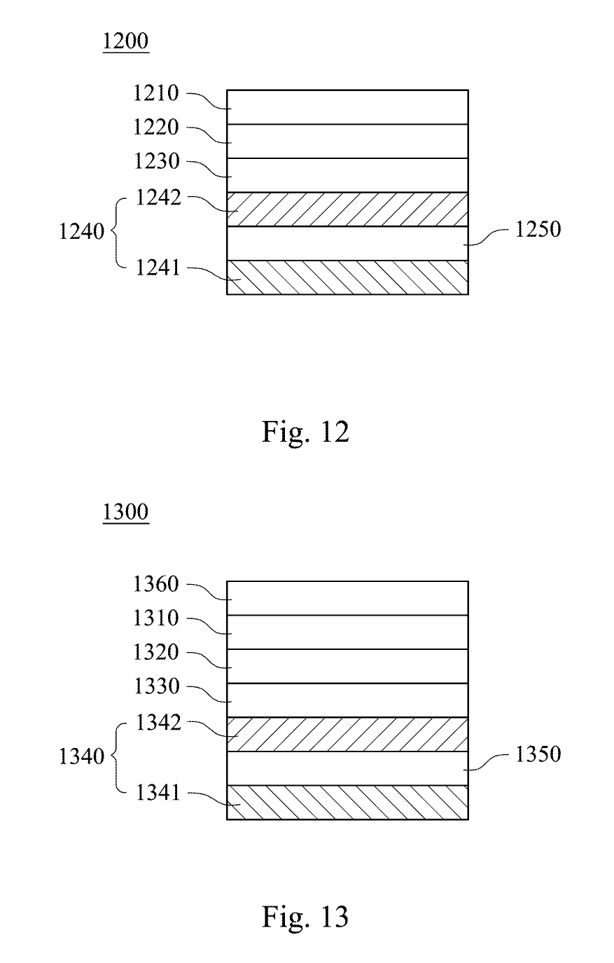

Please refer to FIG. 12. FIG. 12 shows a side view of an invisible light blocking structure 1200 according to a 12th example of the present disclosure. In the 12th example, the invisible light blocking unit 1240 includes an infrared light blocking layer 1241 and an ultraviolet light blocking layer 1242. The invisible light blocking structure 1200 includes, from an upper side to a bottom side, a first transparent substrate 1210, a metal layer 1220, a transparent protecting layer 1230, the ultraviolet light blocking layer 1242, a second transparent substrate 1250 and the infrared light blocking layer 1241. The ultraviolet light blocking layer 1242 is formed by a PVB film with ultraviolet light blocking capacity. The component of the metal layer 1220 is Ag, but the component thereof can be Al, Cr, Ni, In, Ti or Sn in another example. The transparent protecting layer 1230 is a silicon oxide film manufactured by physical vapor deposition and has a thickness of 50 nm. The transparent protecting layer 1230 can be a titanium oxide film or an aluminum oxide film in another example. The infrared light blocking layer 1241 is a continuous cesium tungstate film manufactured by physical vapor deposition and has a thickness of 200 nm. The infrared light blocking layer 1241 can be a discontinuous cesium tungstate film formed from a cesium tungstate-containing silicone sealant in another example.

Please refer to FIG. 13. FIG. 13 shows a side view of an invisible light blocking structure 1300 according to a 13th example of the present disclosure. In the 13th example, the invisible light blocking unit 1340 includes an infrared light blocking layer 1341 and an ultraviolet light blocking layer 1342. The invisible light blocking structure 1300 includes, from an upper side to a bottom side, a self-cleaning layer 1360, a first transparent substrate 1310, a metal layer 1320, a transparent protecting layer 1330, the ultraviolet light blocking layer 1342, a second transparent substrate 1350 and the infrared light blocking layer 1341. The self-cleaning layer 1360 is a continuous fluorine film manufactured by physical vapor deposition and has a thickness of 500 nm. The self-cleaning layer 1360 can be a discontinuous fluorine film formed from a fluorine-containing silicone sealant in another example. The ultraviolet light blocking layer 1342 is formed by a PVB film with ultraviolet light blocking capacity. The component of the metal layer 1320 is Ag, but the component thereof can be Al, Cr, Ni, In, Ti or Sn in another example. The transparent protecting layer 1330 is a silicon oxide film manufactured by physical vapor deposition and has a thickness of 50 nm. The transparent protecting layer 1330 can be a titanium oxide film or an aluminum oxide film in another example. The infrared light blocking layer 1341 is a continuous cesium tungstate film manufactured by physical vapor deposition and has a thickness of 200 nm. The infrared light blocking layer 1341 can be a discontinuous cesium tungstate film formed from a cesium tungstate-containing silicone sealant in another example.

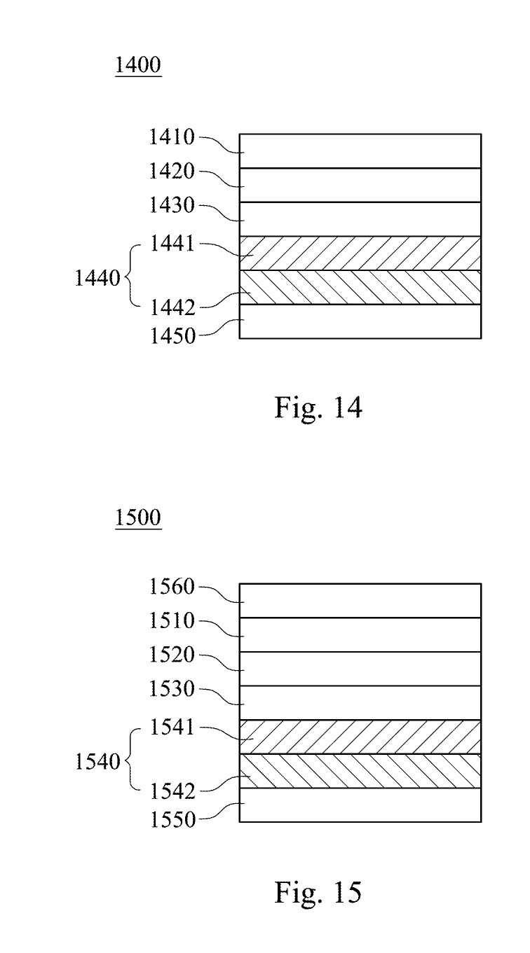

Please refer to FIG. 14. FIG. 14 shows a side view of an invisible light blocking structure 1400 according to a 14th example of the present disclosure. In the 14th example, the invisible light blocking unit 1440 includes an infrared light blocking layer 1441 and an ultraviolet light blocking layer 1442. The invisible light blocking structure 1400 includes, from an upper side to a bottom side, a first transparent substrate 1410, a metal layer 1420, a transparent protecting layer 1430, the infrared light blocking layer 1441, the ultraviolet light blocking layer 1442 and a second transparent substrate 1450. The ultraviolet light blocking layer 1442 is formed by a PVB film with ultraviolet light blocking capacity. The component of the metal layer 1420 is Ag, but the component thereof can be Al, Cr, Ni, In, Ti or Sn in another example. The transparent protecting layer 1430 is a silicon oxide film manufactured by physical vapor deposition and has a thickness of 50 nm. The transparent protecting layer 1430 can be a titanium oxide film or an aluminum oxide film in another example. The infrared light blocking layer 1441 is a continuous cesium tungstate film manufactured by physical vapor deposition and has a thickness of 200 nm. The infrared light blocking layer 1441 can be a discontinuous cesium tungstate film formed from a cesium tungstate-containing silicone sealant in another example.

Please refer to FIG. 15. FIG. 15 shows a side view of an invisible light blocking structure 1500 according to a 15th example of the present disclosure. In the 15th example, the invisible light blocking unit 1540 includes an infrared light blocking layer 1541 and an ultraviolet light blocking layer 1542. The invisible light blocking structure 1500 includes, from an upper side to a bottom side, a self-cleaning layer 1560, a first transparent substrate 1510, a metal layer 1520, a transparent protecting layer 1530, the infrared light blocking layer 1541, the ultraviolet light blocking layer 1542 and a second transparent substrate 1550. The self-cleaning layer 1560 is a continuous fluorine film manufactured by physical vapor deposition and has a thickness of 500 nm. The self-cleaning layer 1560 can be a discontinuous fluorine film formed from a fluorine-containing silicone sealant in another example. The ultraviolet light blocking layer 1542 is formed by a PVB film with ultraviolet light blocking capacity. The component of the metal layer 1520 is Ag, but the component thereof can be Al, Cr, Ni, In, Ti or Sn in another example. The transparent protecting layer 1530 is a silicon oxide film manufactured by physical vapor deposition and has a thickness of 50 nm. The transparent protecting layer 1530 can be a titanium oxide film or an aluminum oxide film in another example. The infrared light blocking layer 1541 is a continuous cesium tungstate film manufactured by physical vapor deposition and has a thickness of 200 nm. The infrared light blocking layer 1541 can be a discontinuous cesium tungstate film formed from a cesium tungstate-containing silicone sealant in another example.

### Comparison Examples

A 1st comparison example includes, from an upper side to a bottom side, a first transparent substrate, an infrared light blocking layer and a transparent protecting layer. The component of the infrared light blocking layer is Ag. The transparent protecting layer is a silicon oxide film manufactured by physical vapor deposition and has a thickness of 50 nm.

A 2nd comparison example includes, from an upper side to a bottom side, a first transparent substrate, an ultraviolet light blocking layer, a second transparent substrate, an infrared light blocking layer and a transparent protecting layer. The ultraviolet light blocking layer is formed by a PVB film with ultraviolet light blocking capability. The component of the infrared light blocking layer is Ag. The transparent protecting layer is a silicon oxide film manufactured by physical vapor deposition and has a thickness of 50 nm.

A 3rd comparison example includes, from an upper side to a bottom side, a first transparent substrate, an infrared light blocking layer, a transparent protecting layer, an ultraviolet light blocking layer and a second transparent substrate. The ultraviolet light blocking layer is formed by a PVB film with ultraviolet light blocking capability. The component of the infrared light blocking layer is Ag. The transparent protecting layer is a silicon oxide film manufactured by physical vapor deposition and has a thickness of 50 nm.

Table 1 shows measurements of ultraviolet light blocking rates (UV R), infrared light blocking rates (IR R) and contact angles of the invisible light blocking structures of the 1st to 15th examples and the 1st to 3rd comparison examples. The ultraviolet light blocking rates and the infrared light blocking rates are measured by EDTM Window Energy Profiler (Model No. WP4500). The measured ultraviolet light wavelength is 365 nm and the measured infrared light wavelength is 950 nm. The contact angles are measured by contact angle meter (GBX, PX610, France).

TABLE 1

| | UV R (%) | IR R (%) | contact angle (°) |
|---|---|---|---|
| 1st comparison example | 40 | 62 | 44.9 |
| 2nd comparison example | 100 | 63 | 44.7 |
| 3rd comparison example | 100 | 62 | 44.9 |
| 1st example | 66 | 96 | 44.6 |
| 2nd example | 66 | 97 | 93.5 |
| 3rd example | 100 | 97 | 44.9 |
| 4th example | 100 | 97 | 93.4 |
| 5th example | 98 | 98 | 44.8 |
| 6th example | 98 | 98 | 93.7 |
| 7th example | 99 | 97 | 93.5 |
| 8th example | 100 | 97 | 44.6 |
| 9th example | 100 | 97 | 93.6 |
| 10th example | 100 | 97 | 44.8 |
| 11th example | 100 | 97 | 93.6 |
| 12th example | 100 | 97 | 44.9 |
| 13th example | 100 | 97 | 93.8 |
| 14th example | 100 | 96 | 44.7 |
| 15th example | 100 | 97 | 93.8 |

As shown in Table 1, the ultraviolet light blocking rates and the infrared light blocking rates of the invisible light blocking structures of the 1st to 15th examples are better, which can prove that each of the invisible light blocking structure of the present disclosure has good capability on blocking ultraviolet light and infrared light. Moreover, when the invisible light blocking structure further includes a self-cleaning layer, the contact angle is large. Hence, vapor pollution can be prevented, and the invisible light blocking structure can remain clean.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An invisible light blocking structure, comprising:
a first transparent substrate having a first bottom side and a first upper side;
a metal layer disposed on the first bottom side and having a first metal side facing away from the first transparent substrate, wherein the first upper side faces away from the metal layer;
a transparent protecting layer disposed on the first metal side, wherein the transparent protecting layer has a first protecting side facing away from the first transparent substrate; and
an invisible light blocking unit disposed on at least one of the first protecting side and the first upper side, wherein the invisible light blocking unit has cesium tungstate.

2. The invisible light blocking structure of claim 1, wherein the invisible light blocking unit is disposed on the first protecting side.

3. The invisible light blocking structure of claim 2, wherein the invisible light blocking unit comprises an infrared light blocking layer, and the infrared light blocking layer comprises:
a cesium tungstate film containing the cesium tungstate.

4. The invisible light blocking structure of claim 2, wherein the invisible light blocking unit comprises an infrared light blocking layer, and the infrared light blocking layer comprises:
a cesium tungstate-containing silicone sealant, comprising:
a polymer-containing silicone sealant colloid, comprising silane resin-containing group, acrylic resin-containing group, polyurethane-containing group and epoxy resin-containing group; and
a plurality of nanoparticles dispersed uniformly in the polymer silicone-sealant colloid and containing the cesium tungstate.

5. The invisible light blocking structure of claim 2, further comprising:
a self-cleaning layer disposed on the first upper side and having fluorine.

6. The invisible light blocking structure of claim 2, further comprising a second transparent substrate, wherein the invisible light blocking unit comprises:
an ultraviolet and infrared light blocking layer having a first blocking side facing away from the transparent protecting layer and comprising:
a polyvinyl butyral resin;
an organic ultraviolet light blocking component dispersed in the polyvinyl butyral resin; and
a plurality of nanoparticles dispersed in the polyvinyl butyral resin and containing the cesium tungstate;
wherein the second transparent substrate is disposed on the first blocking side.

7. The invisible light blocking structure of claim 6, further comprising:
a self-cleaning layer disposed on the first upper side and having fluorine.

8. The invisible light blocking structure of claim 1, wherein the invisible light blocking unit comprises:
an infrared light blocking layer disposed on the first protecting side, wherein the infrared light blocking layer containing the cesium tungstate; and
an ultraviolet light blocking layer disposed between the transparent protecting layer and the infrared light blocking layer, on the first upper side, or on a first side of the infrared light blocking layer, wherein the first side of the infrared light blocking layer faces away from the transparent protecting layer.

9. The invisible light blocking structure of claim 8, further comprising:
a self-cleaning layer disposed on the first upper side and having fluorine.

10. The invisible light blocking structure of claim 8, wherein the ultraviolet light blocking layer has cerium oxide or zinc oxide.

11. The invisible light blocking structure of claim 1, further comprising a second transparent substrate, wherein the invisible light blocking unit comprises:
an infrared light blocking layer disposed on the first protecting side, wherein the infrared light blocking layer contains the cesium tungstate; and
an ultraviolet light blocking layer disposed between the transparent protecting layer and the infrared light blocking layer, between the metal layer and the first transparent substrate, or on a first side of the infrared light blocking layer, wherein the first side of the infrared light blocking layer faces away from the transparent protecting layer;
wherein the second transparent substrate disposed between the first transparent substrate and the metal layer, between the transparent protecting layer and the infrared light blocking layer, or on the first side of the infrared light blocking layer.

12. The invisible light blocking structure of claim 11, wherein the ultraviolet light blocking layer is disposed between the metal layer and the first transparent substrate, and the second transparent substrate is disposed between the ultraviolet light blocking layer and the metal layer.

13. The invisible light blocking structure of claim 11, wherein the ultraviolet light blocking layer is disposed between the transparent protecting layer and the infrared light blocking layer, and the second transparent substrate is disposed between the ultraviolet light blocking layer and the infrared light blocking layer.

14. The invisible light blocking structure of claim 11, wherein the ultraviolet light blocking layer is disposed on the first side of the infrared light blocking layer, and the second transparent substrate is disposed on a first side of the ultraviolet light blocking layer, wherein the first side of the ultraviolet light blocking layer faces away from the transparent protecting layer.

15. The invisible light blocking structure of claim 12, further comprising:
a self-cleaning layer disposed on the first upper side and having fluorine.

16. The invisible light blocking structure of claim 13, further comprising:
a self-cleaning layer disposed on the first upper side and having fluorine.

17. The invisible light blocking structure of claim 14, further comprising:
a self-cleaning layer disposed on the first upper side and having fluorine.

18. The invisible light blocking structure of claim 11, wherein the ultraviolet light blocking layer comprises:
a polyvinyl butyral resin; and
an organic ultraviolet light blocking component dispersed in the polyvinyl butyral resin.
